(19) United States
(12) Patent Application Publication
(10) Pub. No.: US 2005/0102303 A1
(43) Pub. Date: May 12, 2005

(54) Computer-implemented method, system and program product for mapping a user data schema to a mining model schema

(75) Inventors: Feng-Wei Chen Russell, Cary, NC (US); Ameet M. Kini, Sterling, VA (US); John A. Medicke JR., Raleigh, NC (US); Steven M. Miller, Cary, NC (US); Betsy M. Plunket, Raleigh, NC (US); Ashish Sureka, Raleigh, NC (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/706,546

(22) Filed: Nov. 12, 2003

(51) Int. Cl. G06F 17/00

(52) U.S. Cl. 707/101

(57) ABSTRACT

Under the present invention, columns of the user data schema are first matched to corresponding columns of the mining model schema. Once the columns are matched, it will be determined whether data within matching columns of the user data schema has a data type different than data within the corresponding columns of the mining model schema. If so, the data within the matching columns of the user data schema is transformed to match the data type of the data within the corresponding columns of the mining model schema. After any transformation is performed, the user/operator is provided with an opportunity to alter or override the mapping. Once the final mapping is provided, one or more matching resources can be updated to reflect the mapping.

### BACKGROUND OF THE INVENTION

1. Field of the Invention

The present invention generally relates to a computer-implemented method, system and program product for mapping a user data schema to a mining model schema. Specifically, the present invention provides dynamic and intelligent schema matching functionality in an autonomic environment.

2. Related Art

As businesses increasingly rely upon computer technology to perform essential functions, data mining is rapidly becoming vital to business success. Specifically, many businesses gather various types of data about the business and/or its customers so that operations can be gauged and optimized. Typically, a business will gather data into a database or the like and then utilize a data mining scoring tool (e.g., IM Scoring, etc.) to mine the data. Unfortunately, as is well known, the data mining program might utilize a data model or schema that is different from the data schema of the business. In these cases, the businesses' data schemas must be mapped to the data mining schemas.

Traditionally, such mappings have been performed manually, with an operator or the like manually matching columns of the business' data schema to the columns of the data mining schema. However, this is often a tedious and inefficient process. For example, a bank might have a data schema that provides fifty columns of data. In this case, the operator would have to review the names/types of each column and then attempt to find matching columns within the data mining schema. Once the columns were matched, the operator might then have to manually alter the data types of the bank's data schema to match that of the mining model schema. For example, the gender of a customer might be represented in the bank's data schema as a binary “0” or “1,” while being represented as “male” or “female” in the mining model schema. For each case where the data types did not match, the operator would have to either alter the data type so that they matched, or at least determine the differences. Further, since each data mining program could have a different data mining schema, these function would have to be performed for each data mining program the bank wished to implement. Not only are such manual processes inefficiently and costly, but they can also yield inconsistent results. For example, one operator might match the same columns of the bank's data schema differently than another operator. Moreover, columns containing the same type of data (e.g., customer gender) in two different data mining schemas could accidentally be matched with different columns of the bank's data schema.

In view of the foregoing, there exists a need for a computer-implemented method, system and program product for mapping a user data schema to a mining model schema. Specifically, a need exists for a system that can automatically match the columns of a user data schema with the columns of a mining model schema. A further need exists for the system to transform data of the user data schema as necessary so that its data type matches that of the mining model schema. Still yet, a need exists for an operator or the like to be provided with the opportunity to manually alter any of the matchings. Further a need exists for the system to be autonomic and adaptive so that it can learn from previous mappings.

### SUMMARY OF THE INVENTION

In general, the present invention provides a computer-implemented method, system and program product for mapping a user data schema to a mining model schema. Specifically, under the present invention, columns of the user data schema are first matched to corresponding columns of the mining model schema. This matching can be based on an exact match of column names, a similarity of column names as determined by one or more matching resources (e.g., thesaurus, dictionary, similarity threshold, etc.), a formula-based matching based on column names, or an instance-based matching of data within the columns. In any event, once the columns are matched, it will be determined whether data within matching columns of the user data schema has a data type different than data within the corresponding columns of the mining model schema. If so, the data within the matching columns of the user data schema is transformed to match the data type of the data within the corresponding columns of the mining model schema. After any transformation is performed, the user/operator is provided with an opportunity to alter or override the mapping. Once the final mapping is provided, the matching resources can be updated to reflect the mapping.

A first aspect of the present invention provides a computer-implemented method for mapping a user data schema to a mining model schema, comprising: matching columns of the user data schema to corresponding columns of the mining model schema to provide a mapping; determining whether data within matching columns of the user data schema has a data type different than data within the corresponding columns of the mining model schema; transforming the data within the matching columns of the user data schema if the data type is determined to be different; and updating a matching resource based on the mapping.

A second aspect of the present invention provides a computer-implemented method for mapping a user data schema to a mining model schema, comprising: populating a schema consolidation table with names of columns of the mining model schema; mapping the user data schema to the mining model schema by matching columns of the user data schema to corresponding columns of the mining model schema; determining whether data within matching columns of the user data schema has a data type different than data within the corresponding columns of the mining model schema; transforming the data within the matching columns of the user data schema if the data type is determined to be different; providing an opportunity to manually alter the mapping after transforming the data; presenting a final view of the mapping after providing the opportunity to manually alter the mapping; and updating a matching resource and the schema consolidation table based on the mapping.

A third aspect of the present invention provides a computerized system for mapping a user data schema to a mining model schema, comprising: a column matching system for matching columns of the user data schema to corresponding columns of the mining model schema to provide a mapping; a model differentiation system for determining whether data within matching columns of the user data schema has a data type different than data within the corresponding columns of the mining model schema; a data transformation system for transforming the data within the matching columns of the user data schema if the data type is determined to be different; and an update system for updating a matching resource based on the mapping.

A fourth aspect of the present invention provides a program product stored on a recordable medium for mapping a user data schema to a mining model schema, which when executed, comprises: program code for matching columns of the user data schema to corresponding columns of the mining model schema to provide a mapping; program code for determining whether data within matching columns of the user data schema has a data type different than data within the corresponding columns of the mining model schema; program code for transforming the data within the matching columns of the user data schema if the data type is determined to be different; and program code for updating a matching resource based on the mapping.

Therefore, the present invention provides a computer-implemented method, system and program product for mapping a user data schema to a mining model schema.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for mapping a user data schema to a mining model schema according to the present invention.

FIG. 2 depicts an illustrative user data schema and mining model schema according to the present invention.

FIG. 3 depicts an illustrative schema consolidation table as populated with column names from the mining model schema according to the present invention.

FIG. 4 depicts an illustrative final view as presented to a user according to the present invention.

FIG. 5 depicts the schema consolidation table of FIG. 3 as populated with column names from the user data schema according to the present invention.

FIG. 6 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a computer-implemented method, system and program product for mapping a user data schema to a mining model schema. As known, each data mining model contains a schema that describes the fields used in that model and which a user has to provide in order to apply the model. The specification of the mining model schema are defined in Predictive Model Markup Language (PMML). The present invention particularly applies in using the schema described in the PMML as well as the actual data on which the model is built to match the schema of the data to that on which the user wishes to apply the model.

Specifically, under the present invention, columns of the user data schema are first matched to corresponding columns of the mining model schema. This matching can be based on an exact match of column names, a similarity of column names as determined by one or more matching resources (e.g., thesaurus, dictionary, similarity threshold, etc.), a formula-based matching of column names, or an instance-based matching of data within the columns. In any event, once the columns are matched, it will be determined whether data within matching columns of the user data schema has a data type different than data within the corresponding columns of the mining model schema. If so, the data within the matching columns of the user data schema is transformed to match the data type of the data within the corresponding columns of the mining model schema. After any transformation is performed, the user/operator is provided with an opportunity to alter or override the mapping. Once the final mapping is provided, the matching resources can be updated to reflect the mapping.

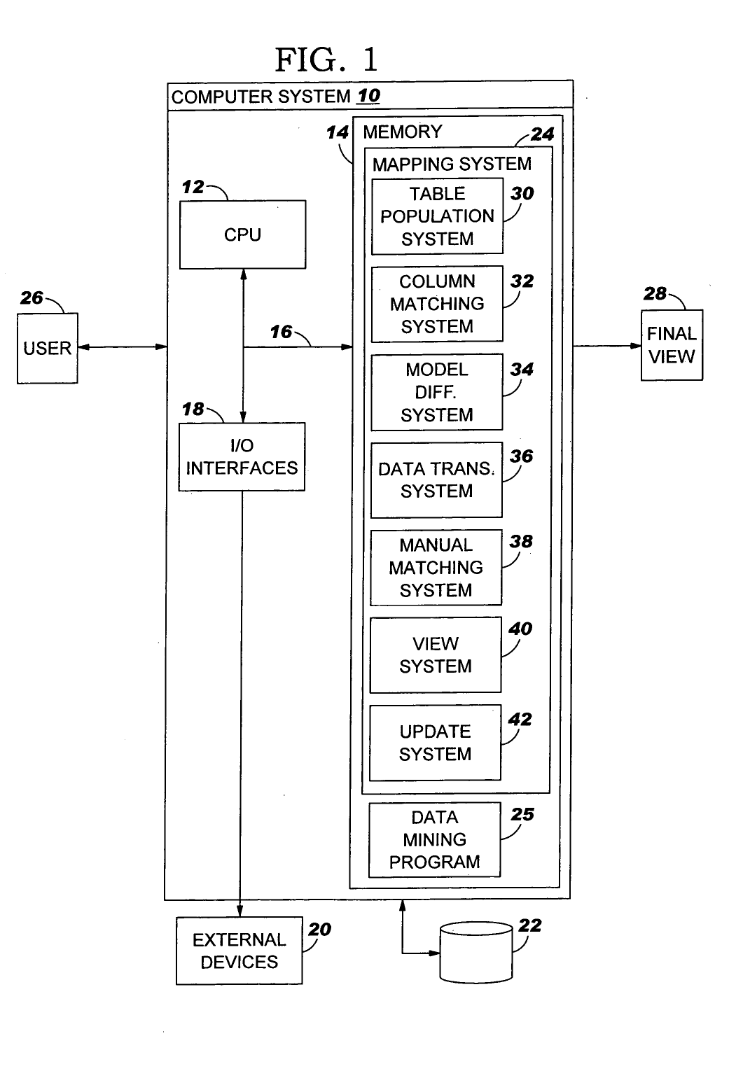

Referring now to FIG. 1, a system for mapping a user data schema to a mining model schema is depicted. Under the present invention, mapping system 24 on computer system 10 will map a user data schema (e.g., for storage unit 22) to a mining model schema (e.g., as used by mining program 25). As indicated above, organizations such as banks and the like commonly maintain various types of data. To this extent, such organizations often utilize one or more mining (scoring) programs 25 to mine/analyze the data. A typical example of a mining scoring program is IM Scoring. Unfortunately, mining programs often use a different data schema than do individual organizations. Accordingly, before the data can be effectively mined, the user data schema of the organization must be mapped to the mining model schema. Prior to the present invention, the mapping was performed manually.

Computer system 10 is intended to represent any type of computerized device implemented by an organization and capable of executing programs and performing the functions described herein. For example, computer system 10 could be a personal computer, a handheld device, a workstation, etc. In addition, computer system 10 could be implemented as a stand-alone system, or as part of a computerized network such as the Internet, local area network (LAN), wide area network (WAN), virtual private network (VPN), etc. If implemented within a network, computer system 10 could represent a client or a server. As known, communication between clients and a server could occur via a direct hardwired connection (e.g., serial port), or via an addressable connection that may utilize any combination of wireline and/or wireless transmission methods. The server and the clients may utilize conventional network connectivity, such as Token Ring, Ethernet, WiFi or other conventional communications standards. Moreover, connectivity could be provided by conventional TCP/IP sockets-based protocol. In this instance, the clients could utilize an Internet service provider to establish connectivity to the server.

Regardless of its implementation, computer system 10 could be operated by an organization wishing to map its “user” data schema to a mining model schema of data mining program 25. As shown, computer system 10 generally comprises central processing unit (CPU) 12, memory 14, bus 16, input/output (I/O) interfaces 18, external devices/resources 20 and storage unit 22. CPU 12 may comprise a single processing unit, or be distributed across one or more processing units in one or more locations, e.g., on a client and computer system. Memory 14 may comprise any known type of data storage and/or transmission media, including magnetic media, optical media, random access memory (RAM), read-only memory (ROM), a data cache, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LCD screen, handheld device, keyboard, mouse, voice recognition system, speech output system, printer, monitor/display, facsimile, pager, etc. Bus 16 provides a communication link between each of the components in computer system 10 and likewise may comprise any known type of transmission link, including electrical, optical, wireless, etc.

Storage unit 22 can be any system (e.g., database) capable of providing storage for data. As such, storage unit 22 could include one or more storage devices, such as a magnetic disk drive or an optical disk drive. In another embodiment, storage unit 22 includes data distributed across, for example, a local area network (LAN), wide area network (WAN) or a storage area network (SAN) (not shown). Further, although not shown, additional components, such as cache memory, communication systems, system software, etc., may be incorporated into computer system 10.

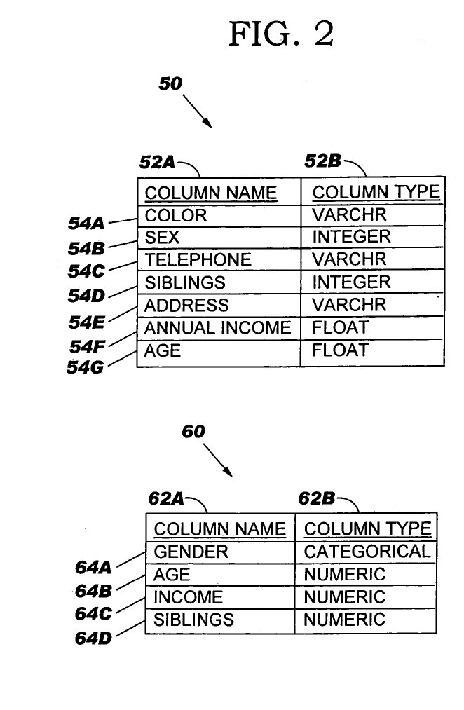

Referring to FIG. 2, an illustrative user data schema 50 and mining model schema 60 are shown. User data schema 50 is intended to depict a possible data schema implemented within storage unit 22 (FIG. 1) and mining model schema is intended to depict a possible data schema implemented by mining program 25. Each data schema 50 and 60 sets forth the categories or names of data collected and the data value types corresponding thereto. For example, user data schema 50 includes columns 52A-B and rows 54A-G. Column 52A sets forth the column names/categories of data (hereinafter referred to as “column names”) collected pursuant to the user data schema, while column 52B sets forth the type of data values collected for each corresponding column name. For example, row 54B indicates that the “sex” of a person is collected pursuant to user data schema 50 as an integer (e.g., binary 0 or 1). Similarly, mining model schema 60 includes columns and rows setting forth the categories of data collected and the data value types corresponding thereto. However, as shown, identical column names are not necessarily provided for each schema. For example, mining model schema 60 does not include a “telephone” column name such as shown in row 54C of user data schema 50. Accordingly, in order for mining program 25 (FIG. 1) to properly mine data collected under user data schema 50, the two schemas 50 and 60 should be mapped to each other. Moreover, even if the two schemas 50 and 60 have column names in common, the types of data values might differ. For example, the “age” column name of row 64B of mining model schema uses a “numeric” data type, while the “age” column name of row 54G of user data schema using a “floating” data type. Therefore, transformation of data within user data schema 50 to match the data type of corresponding data within mining model schema 60 might be necessary for accurate mining.

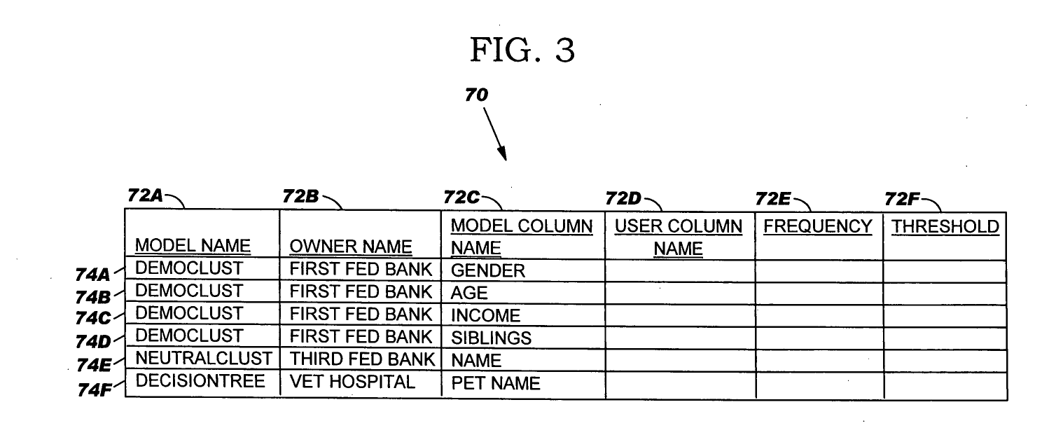

Referring to FIGS. 1 and 2 collectively, the functions of the present invention will be described in greater detail. As shown, mapping system 24 includes table population system 30, column matching system 32, model differentiation system 34, data transformation system 36, manual matching system 38, view system 40 and update system 42. Once the two schemas 50 and 60 are provided, table population system 30 will first populate a schema consolidation table with information from data mining schema 60. Referring briefly to FIG. 3, an illustrative schema consolidation table 70 is depicted. As shown, schema consolidation table 70 includes columns 72A-F for containing various pieces of information. The first three columns 72A-C are where details regarding mining model schema 60 (FIG. 2) are populated, while remaining columns 72D-F will be populated with information after the mapping is complete. In any event column 72A is where the name(s) of the mining model schemas/programs are kept. For example, rows 74A-D under column 72A pertains to mining model schema 60 (entitled “DemoClust”), row 74E pertains to the mining model schema entitled “NeutralClust, and row 74F pertains to for the mining model schema entitled “DecisionTree.” Column 72B lists the organizations for which the mining model schemas of column 72A are used. For example, mining model schema 60 will be used to mine data for “First Fed Bank,” which itself utilizes user data schema 50 (FIG. 2). Column 72C lists the column names for the mining model schemas. As can be seen, the column names set forth in rows 62A-D of mining model schema 60 are populated into rows 74A-D of column 72C. In a typical embodiment, column names are stemmed prior to population into schema consolidation table 70. For example, “ages” and “aging” would be stemmed to “age.” In any event, as will be further described below, the remaining columns 72D-F will be populated after user data schema 50 is mapped to mining model schema 60.

Referring back to FIGS. 1 and 2, once the schema population table is populated with information from mining model schema 60, column matching system 32 will automatically match the columns of user data schema 50 to mining model schema 60. Specifically, the columns names of each data schema will be automatically matched together. Under the present invention, a four step matching process is typically implemented to match the columns names. First, column matching system 32 will look for exact column name matches. In one embodiment, this can be accomplished using a native SQL query or the like such as

```
      Select ModelColName from Schema_Consolidation SC,
      UserINputTable UT
where SC.modelname=”DemoClus”
      and S.C.USerColName=UT.ColumnName
```

In comparing schemas 50 and 60, it can be seen that two exact column name matches are present, namely, “age” and “siblings.” Accordingly, the “age” column name of row 54G of user data schema 50 will be mapped to the “age” column name of row 64B of mining model schema 60, while the “siblings” column name of row 54D of user data schema 50 is mapped to the “siblings” column name of row 64D of mining model schema 60.

Once any exact matches are determined, column matching system 32 will then perform the second step of the matching process by determining whether any column names of user data schema 50 are “similar” to those of mining model schema 60. Similarity can be established by performing a fuzzy and/or synonym search using one or more matching resources such as a dictionary, a thesaurus, a similarity threshold table, etc. For example, although column names might not be identical, they might contain slight spelling variations such as upper/lower case usage, underscores, spaces between words, or misspellings. Column matching system 32 can be configured to allow such differences in matching two columns together. That is, column matching system 32 can be programmed with a similarity threshold for allowing such variations. Thus, the “annual income” column name of row 54F of user data schema 50 would be matched to the “income” column name of row 64C of mining model schema 60. Alternatively, the column names might be spelled correctly, but be synonyms of each other. In matching synonyms the matching resources could be consulted to build a search for terms that are synonyms or participate in some semantic relation with the column name involved. Examples of such relations are A SPECIFIC TYPE OF (sports˜soccer), A GENERAL TYPE OF (SocialSecurityNumber˜ID). The following SQL language illustrates one possible way to perform such linguistic matching:

```
      WITH TEMTABLE(ModelColName,Score)
      AS (SELECT cast(ModelColName as char(60)),
      SCORE(ModelColName, ‘THESAURUS “nseamplethes”
      EXPAND SYNONUM
TERM OF “annual_income” ’)
      FROM FWCHEN.SCHEMA_CONSOLIDATION
      union all
      SELECT CAST(ModelColName as char(60)),
      SCORE(ModelColName, ‘fuzzy form of 90 “annual!_income”
      ESCAPE “!” ’)
      FROM FWCHEN.SCHEMA_CONSOLIDATION
      SELECT *
      FROM TEMPTABLE
      WHERE score > 0
      ORDER BY score DESC
```

Using the above language, the “annual income” column name of row 54F of user data schema 50 would be matched to the “income” column name of row 64C of mining model schema 60. Similar language could be provided to match the “sex” column name of row 54B of user data schema 50 to the “gender” column name of row 64A of mining model schema.

Once any similar column names are matched, a formula-based matching process could be performed by column matching system 32. Specifically, column names might contain similar data that represents the same type of information, but with different representations. The present invention will thus match the column names of user data schema 50 to the column names of mining model schema 60 based on one or more “conversion” formulae. For example, this could include mapping MONTHS to YEARS, DAYS to DATE, FEET to METERS, TEMPERATURE C TO TEMPERATURE K, etc. Although each of these names might not be not exact matches or synonyms, they can still be matched.

After the formula-based matching process has been performed, column matching system 32 could then perform an instance-based matching process as the fourth step in the column matching process. Specifically, whereas the linguistic matching schemes focus on the syntactic structure of the column names of the schemas, the instance-based matching focuses on the actual data values in order to find mappings. To this extent, the instance-based matching operation attempts to find data within user data schema 50 that corresponds to data within mining model schema in order to match columns. This is generally accomplished by finding ranges (e.g., through a one-pass inspection) of the different columns of data to find a similarity relationship between user data schema 50 and mining model schema 60. In a typical embodiment, column matching system 32 will consider four scenarios for instance-based matching.

(1) Exact Fit: The ranges of both columns are identical and hence, there is a high probability that the two columns can participate in a valid mapping. For example, Range(Column A)=(1, 10) and Range (Column B)=(1, 10).

(2) Containment: One of the ranges is exactly contained within the other. For example, Range(ColumnA)=(1, 10) and Range(Column B)=(5, 10). In this case, compliance of the data with specified constraints is validated to help prevent incorrect recommendations of schema mapping.

(3) Overlap: Both ranges have a common region. For example, Range(ColumnA) =(1, 10) and Range(Column B)=(5, 50).

(4) Disjoint: The ranges have no regions in common, For example, Range(ColumnA)=(1, 10) and Range(Column B)=(100, 200). Since there is no relationship between the data therein, column matching system 32 will reject any mapping therebetween.

Based on these four instance-based matching scenarios, column matching system 32 can derive instance-based mappings in a decreasing order of confidence. Regardless, column matching system 32 will match the columns using the three techniques (e.g., exact matching, similarity matching and instance-based matching) described above.

Once the columns of user data schema 50 are matched with corresponding columns of mining model schema 60, model differentiation system 34 will determine whether data within matching columns of user data schema 50 has a data type different than data within the corresponding columns of mining model schema 60. For example, the “sex” column name of row 54B of user data schema 50 has an “integer” data type (e.g., binary 0 or 1), while the corresponding matching column name “gender” of row 64A of mining model schema has a “categorical” data type (e.g., male or female). Each instance in which data within matching columns have different data types are identified under the present invention. Once identified, data transformation system 36 will transform such instances within the matching columns of user data schema 50 to match the data type of the corresponding columns of mining model schema 60. For example, the “integer” data type for data of row 54B will be transformed into the “categorical” data type for data of row 64A.

Once any data types are transformed as necessary, a final matching can be presented to user 26, who is then provided with the opportunity to override/alter the matchings via manual matching system 38. Based on user data schema 50 and mining model schema 60, the following matchings should be presented to user 26:
Sex—Gender
Age—Age
Annual Income—Income
Siblings—Siblings
   If any inaccurate matches were automatically made by column matching system 32, user 26 can make changes as necessary. For example, if column matching system 32 incorrectly matched “telephone” of user data schema 50 with “siblings” of mining model schema 60, user 26 could utilize manual matching system 38 to alter such matching.

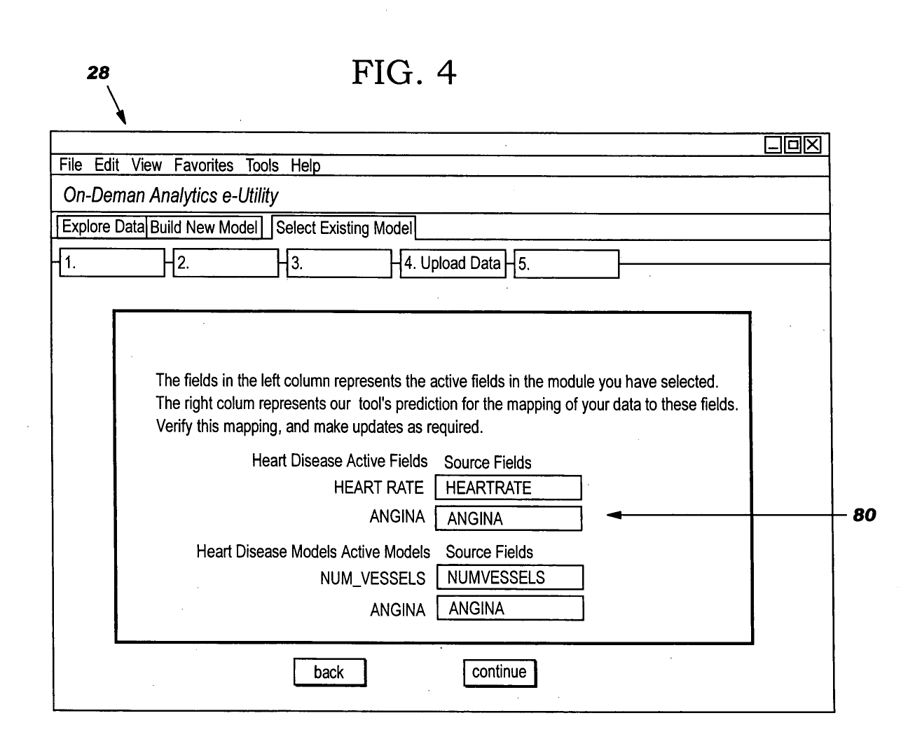

After user 26 has had an opportunity to alter any of the matches, view system 40 will present user 26 with a final view of the matches. Referring to FIG. 4, an illustrative final view 28 is depicted. As shown, final view 28 depicts the final matching of column names 80. In general, the final view could be developed with the following program code:

Create view InputTableView ( gender, age, income, siblings) as
Select (sex, age, annual_income, siblings)
from inputTable

Referring back to FIGS. 1 and 2, once the final view is presented to user 26, update system 42 will update any matching resources based on the mapping. For example, if “sex” was mapped to “gender” for the first time, an entry could be created in the thesaurus. In addition, the frequency of any particular mappings will be updated as will its corresponding similarity threshold. Thus the present invention is autonomic, dynamic, intelligent and adaptive by learning from previous mapping operations.

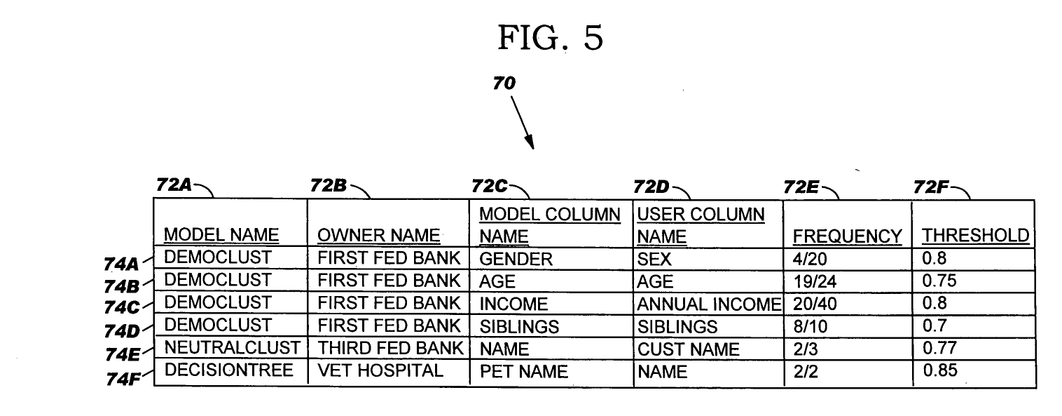

Thereafter, table population system 30 will populate the schema consolidation table with the final mapping information. For example, referring to FIG. 5, schema consolidation table 70 after final population is shown. As depicted, column 72D contains the column names for the user data schema that matched those of column names for the mining model schema shown in column 72C. Column 72E contains the up to date frequencies for the particular matchings. Specifically, the frequencies are generally calculated as the number of times that particular mappings have been approved in the past. For example, “gender” has been mapped to “sex” four out of twenty times. In addition, column 72F contains the similarity thresholds for making the matchings. The thresholds are returned based on the similarity of the column names. In determining the similarities, any known methodology (e.g., simple string difference functions, distance vectors, etc.) could be used.

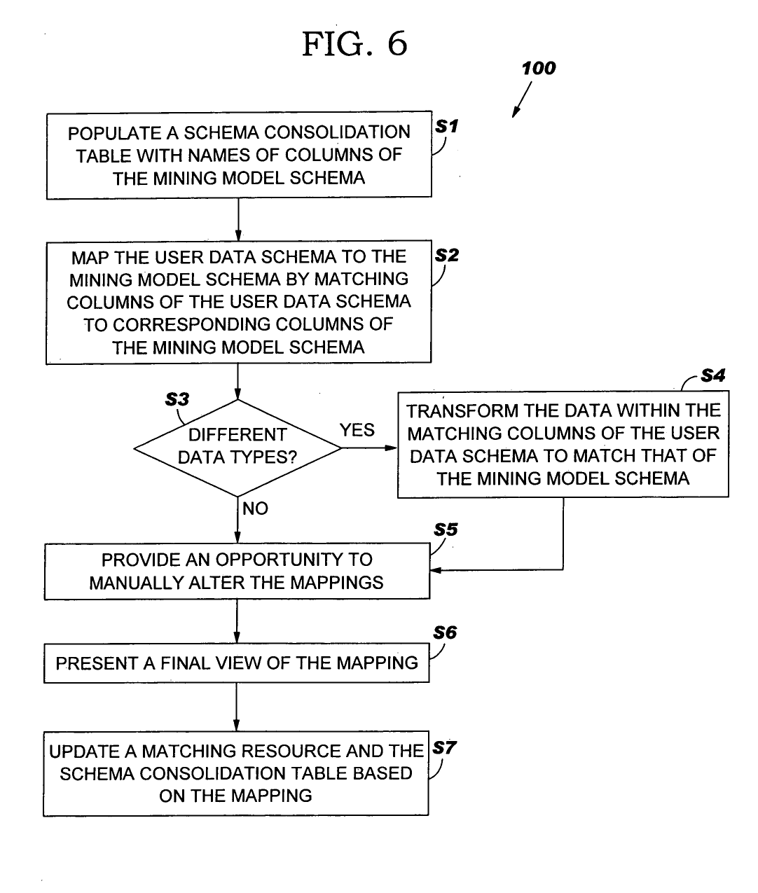

Referring now to FIG. 6, a method flow diagram 100 according to the present invention is shown. As depicted, first step is to populate the schema consolidation table with information from the mining model schema. Second step S2 is to map the user data schema to the mining model schema by matching columns of the user data schema to corresponding columns of the mining model schema. Third step S3 is to determine whether data within the matching columns of the user data schema has a data type different than data within the corresponding columns of the mining model schema. If so, the data within the matching columns of the user data schema is transformed in step S4. In step S5, a user is provided an opportunity to manually alter the mapping after transforming the data. In step S6 a final view of the mapping is presented. After the final view is presented, any matching resources and the schema consolidation table are updated based on the mapping in step S7.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computer-implemented method for mapping a user data schema to a mining model schema, comprising:
matching columns of the user data schema to corresponding columns of the mining model schema to provide a mapping;
determining whether data within matching columns of the user data schema has a data type different than data within the corresponding columns of the mining model schema;
transforming the data within the matching columns of the user data schema if the data type is determined to be different; and
updating a matching resource based on the mapping.

2. The method of claim 1, further comprising:
providing an opportunity to manually alter the mapping after transforming the data; and
presenting a final view of the mapping after providing the opportunity, wherein the updating step is performed after the final view is presented.

3. The method of claim 1, wherein the matching step comprises determining whether names of the columns of the user data schema exactly match names of the columns of the mining model data schema.

4. The method of claim 3, wherein the matching step further comprises determining whether the names of the columns of the user data schema are similar to the names of the columns of the mining model data schema based on the matching resource.

5. The method of claim 4, wherein the matching step comprises determining whether the names of the columns of the user data schema match the names of the columns of the mining model schema based on one or more formulae.

6. The method of claim 5, wherein the matching step further comprises determining whether the data within the columns of the user data schema corresponds to the data within the columns of the mining model data schema.

7. The method of claim 1, wherein the matching resource is selected from the group consisting of a thesaurus, a dictionary and a similarity threshold.

8. The method of claim 1, further comprising:
populating a schema consolidation table with names of the columns of the mining model schema, prior to the matching step; and
updating the schema consolidation table with names of the matching columns of the user data schema, during the updating step.

9. A computer-implemented method for mapping a user data schema to a mining model schema, comprising:
populating a schema consolidation table with names of columns of the mining model schema;
mapping the user data schema to the mining model schema by matching columns of the user data schema to corresponding columns of the mining model schema;
determining whether data within matching columns of the user data schema has a data type different than data within the corresponding columns of the mining model schema;
transforming the data within the matching columns of the user data schema if the data type is determined to be different;
providing an opportunity to manually alter the mapping after transforming the data;
presenting a final view of the mapping after providing the opportunity to manually alter the mapping; and
updating a matching resource and the schema consolidation table based on the mapping.

10. The method of claim 9, wherein the matching step comprises determining whether names of the columns of the user data schema exactly match names of the columns of the mining model schema.

11. The method of claim 10, wherein the matching step further comprises determining whether the names of the columns of the user data schema are similar to the names of the columns of the mining model data schema based on the matching resource.

12. The method of claim 11, wherein the matching step comprises determining whether the names of the columns of the user data schema match the names of the columns of the mining model schema based on one or more formulae.

13. The method of claim 12, wherein the matching step further comprises determining whether the data within the columns of the user data schema corresponds to the data within the columns of the mining model data schema.

14. The method of claim 9, wherein the matching resource is selected from the group consisting of a thesaurus, a dictionary and a similarity threshold.

15. The method of claim 9, wherein the step of updating the schema consolidation table comprises updating the schema consolidation table with names of the matching columns of the user data schema.

16. A computerized system for mapping a user data schema to a mining model schema, comprising:
a column matching system for matching columns of the user data schema to corresponding columns of the mining model schema to provide a mapping;
a model differentiation system for determining whether data within matching columns of the user data schema has a data type different than data within the corresponding columns of the mining model schema;
a data transformation system for transforming the data within the matching columns of the user data schema if the data type is determined to be different; and
an update system for updating a matching resource based on the mapping.

17. The system of claim 16, further comprising:
a manual matching system for providing an opportunity to manually alter the mapping after transforming the data; and
a view system for presenting a final view of the mapping after providing the opportunity.

18. The system of claim 16, wherein the column matching system determines whether names of the columns of the user data schema exactly match names of the columns of the mining model data schema.

19. The system of claim 18, wherein the column matching system further determines whether the names of the columns of the user data schema are similar to the names of the columns of the mining model data schema based on the matching resource.

20. The system of claim 19, wherein the column matching system further determines whether the names of the columns of the user data schema match the names of the columns of the mining model schema based on one or more formulae.

21. The system of claim 20, wherein the column matching system further determines whether the data within the columns of the user data schema corresponds to the data within the columns of the mining model data schema.

22. The system of claim 16, wherein the matching resource is selected from the group consisting of a thesaurus, a dictionary and a similarity threshold.

23. The system of claim 16, further comprising a table population system for populating a schema consolidation table with names of the columns of the mining model schema, wherein the update system further updates the schema consolidation table with names of the matching columns of the user data schema.

24. A program product stored on a recordable medium for mapping a user data schema to a mining model schema, which when executed, comprises:
program code for matching columns of the user data schema to corresponding columns of the mining model schema to provide a mapping;
program code for determining whether data within matching columns of the user data schema has a data type different than data within the corresponding columns of the mining model schema;
program code for transforming the data within the matching columns of the user data schema if the data type is determined to be different; and
program code for updating a matching resource based on the mapping.

25. The program product of claim 24, further comprising:
program code for providing an opportunity to manually alter the mapping after transforming the data; and
program code for presenting a final view of the mapping after providing the opportunity.

26. The program product of claim 24, wherein the program code for matching determines whether names of the columns of the user data schema exactly match names of the columns of the mining model data schema.

27. The program product of claim 26, wherein the program code for matching further determines whether the names of the columns of the user data schema are similar to the names of the columns of the mining model data schema based on the matching resource.

28. The program product of claim 27, wherein the column matching system further determines whether the names of the columns of the user data schema are similar to the names of the columns of the mining model schema based on one or more formulae.

29. The program product of claim 28, wherein the program code for matching further determines whether the data within the columns of the user data schema corresponds to the data within the columns of the mining model data schema.

30. The program product of claim 24, wherein the matching resource is selected from the group consisting of a thesaurus, a dictionary and a similarity threshold.

31. The program product of claim 24, further comprising a program code for populating a schema consolidation table with names of the columns of the mining model schema, wherein the program code for updating further updates the schema consolidation table with names of the matching columns of the user data schema.
